(19) United States
(12) Patent Application Publication
(10) Pub. No.: US 2018/0118169 A1
(43) Pub. Date: May 3, 2018

(54) WIPER SYSTEM FOR VEHICLE, AND METHOD FOR OPERATING THE SAME

(71) Applicants: Hyundai Motor Europe Technical Center GmbH, Russelsheim (DE); Hyundai Motor Company, Seoul (KR); Kia Motors Corporation, Seoul (KR)

(72) Inventors: Michael Schreiber, Frankfurt Am Main (DE); Dominik Matheis, Hanau (DE); Stefan Lessmann, Frankfurt Am Main (DE)

(21) Appl. No.: 15/375,583

(22) Filed: Dec. 12, 2016

(30) Foreign Application Priority Data
Oct. 27, 2016 (DE) 102016221175.7

(51) Int. Cl. B60S 1/08

(52) U.S. Cl. CPC B60S 1/0822; B60S 1/0859; B60S 1/0866

(57) ABSTRACT

A wiper system for a vehicle includes a first micromechanical device configured to detect a first ambient condition and a second micromechanical device configured to detect a second ambient condition. The first micromechanical device is configured to communicate with the second micromechanical device, and the first ambient condition is different to the second ambient condition. The first micromechanical device and the second micromechanical device are configured to operate at least one wiper such that the first ambient condition and the second ambient condition are fulfilled. The at least one wiper of the wiper system is configured to remove moisture of a window of the vehicle.

### BACKGROUND

### (a) Technical Field

The present disclosure relates to a wiper system for a vehicle and a method for operating the same, more particularly, to a wiper system and method including first and second micromechanical devices for detecting first and second ambient conditions, respectively.

### (b) Description of the Related Art

Especially during cold weather (e.g., the winter months), the front windshield and rear windows of a vehicle may be covered with snow and/or ice. Typically this issue occurs when the temperature significantly falls (e.g., at night) in conjunction with condensed water, moisture, high air humidity and/or rain.

To avoid an ice-covered windshield, covers or special coatings are used for the vehicle windows. Other measures like parked-car heating systems or heated windshields are cost-intensive and may require adding optional components to the vehicle.

Therefore, there is a need to improve a wiper system such that icing of the windows can be prevented in an efficient and cost saving manner.

### SUMMARY

According to one aspect the disclosure, a wiper system for a vehicle includes: a first micromechanical device configured to detect a first ambient condition. The wiper system further includes a second micromechanical device configured to detect a second ambient condition. The first micromechanical device is configured to communicate with the second micromechanical device, and the first ambient condition is different to the second ambient condition. The first micromechanical device and the second micromechanical device are configured to operate at least one wiper such that the first ambient condition and the second ambient condition are fulfilled. The at least one wiper of the wiper system is configured to remove moisture of at least one window of the vehicle.

According to a further aspect of the disclosure, a method for operating a wiper system includes steps of: arranging a first micromechanical device configured to detect a first ambient condition and a second micromechanical device configured to detect a second ambient condition in a vehicle such that the first micromechanical device communicates with the second micromechanical device. The first ambient condition preferably is different from the second ambient condition. The method includes in a further step operating at least one wiper by the first micromechanical device and the second micromechanical device such that the first ambient condition and the second ambient condition are fulfilled and removing moisture of the windows via the at least one wiper.

The first and second micromechanical devices can be, e.g., already existing components of the vehicle. Therefore, the wiper system can be produced in a cost saving manner and can be easily integrated in an on-board system of an automobile.

The term “at least one wiper” includes but is not limited to: windshield wipers, rear window wipers, and headlight wipers. The vehicle can include one, two, or a plurality of wipers which can be configured to be operated by the wiper system.

The present disclosure uses in particular the finding that icing to the windows occurs under predefined atmospheric or ambient conditions which can be easily detected with standard components of the vehicle or the automobile. To remove the moisture of, for example, the windshield or the rear window, the first and second micromechanical devices can be easily adjusted, tuned or calibrated.

The first and second micromechanical devices have inter alia the advantage that the detection of the corresponding first and second ambient conditions can be conducted, in particular, autonomously. So a malfunction of wiper system can be easily prevented, because the first and the second ambient conditions have to be fulfilled simultaneously to operate the at least one wiper.

In other words, the wiper system is configured to avoid at least partially the icing of the windows by removing the moisture before it starts to freeze.

The wiper system can be operated preferably when the vehicle is parked, but is not limited to a parking mode. Alternatively, the wiper system can be also operated or initiated during a traffic jam, especially during cold weather.

According to a further embodiment, the moisture comprises condensed water and/or rain. The term “moisture” refers to different physical states of water before being frozen on the window. In other words, the wiper system functions in conjunction with the first and second micromechanical devices, wherein the physical state of the moisture can be in a liquid and/or solid (frozen) state.

According to a further embodiment, the first micromechanical device is a temperature sensor, and the first ambient condition is fulfilled when an outside or an ambient temperature is between 0° C. and 5° C. Preferably the ambient temperature is between 0° C. and 3° C., and more preferably, between 0° C. and 2° C. In other words, the wiper system functions within the ambient or the outside temperature range of 0° C. to 5° C., preferably between 0° C. and 3° C., and more preferably between 0° C. and 2° C.

According to a further embodiment, the second micromechanical device is a rain sensor, and the second ambient condition is fulfilled when the moisture is detected on the window screen. Thus, the moisture, in particular, the condensed water, can be easily detected.

The rain sensor detects the amount of moisture on the windshield. A light or beam emitted from light emitting diodes (LED) is totally reflected on an external surface of the windshield and comes back to photo diodes. When there is water on the external surface of the windshield, the light is optically separated and reflected partially and the remaining brightness is measured by the photo diodes. The moisture remaining on the windshield demonstrates that the light cannot be totally reflected. Therefore, the moisture on the external surface of the windshield can be easily detected.

Further, a sensitivity of the rain sensor can be adjusted to be higher during the night and darkness, respectively.

According to a further embodiment, the second micromechanical device is an air humidity sensor, and the second ambient condition is fulfilled when the moisture is detected on the windows due to an outside or ambient humidity above 95%. A sensitivity of the air humidity sensor can be adjusted to be higher during night and darkness, respectively. Thus, the moisture, in particular the condensed water, can be easily detected.

According to a further embodiment, the second micromechanical device is a humidity sensor, and the second ambient condition is fulfilled when the moisture is detected on the windows due to a dew point higher than an ambient or outside temperature. The dew point or dew point temperature is the temperature at which a given concentration of water vapor in air forms dew. More specifically, it is a measure of atmospheric moisture. A sensitivity of the humidity sensor can be adjusted to be higher during night and darkness, respectively. Thus, the moisture, in particular the condensed water, can be easily detected.

Consequently, the wiper system can be initiated by detecting the first ambient condition. In case the first ambient condition is fulfilled, the second micromechanical device to detect the second ambient condition can be initiated. Alternatively, the detection of the first and second ambient conditions can be conducted simultaneously.

In the temperature range the wiper systems starts to operate the at least one wiper in conjunction with the first ambient conditions. Thus, the wiper system can be operated in a cost-saving manner.

An additional implementation that can further improve a performance of the wiper system can be, for example, to include a weather forecast via an on-board Internet connection with a GPS position of the vehicle in the decision to activate the wiper system. If it is not expected that the outside temperature falls below 3° C. for example the removal of the moisture by the wiper system can be neglected. The wiper system can be therefore connected to the on-board Internet in conjunction with its GPS position.

According to a further embodiment, the at least one wiper is configured to remove the moisture of a field of view of the windshield or rear window. Thus, the wiper system can be easily integrated in a standard windscreen washer system of the vehicle.

According to a further embodiment, the at least one wiper is configured to operate under reduced wiper speed on the condition that the first ambient condition and the second ambient condition are fulfilled. Thus, the wiper systems can be configured to prevent that the removed moisture, the removed condensed water and/or the removed rain contaminates objects or persons which can be for example located around the vehicle.

The above described features disclosed for the wiper system also apply to the method for operating the wiper system and vice versa.

### BRIEF DESCRIPTION OF THE DRAWINGS

A brief description of the drawings will be provided to more sufficiently understand the drawings which are used in the detailed description of the present disclosure.

FIG. 1A is a schematic side view of a vehicle with a wiper system according to an embodiment of the disclosure.

FIG. 1B is an enlarged schematic side view of the vehicle with the wiper system of FIG. 1A.

FIGS. 2A and 2B are schematic front views of a vehicle with a wiper system according to a further embodiment of the disclosure.

FIG. 3 is a flowchart illustrating a method for operating the wiper system according to the disclosure.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

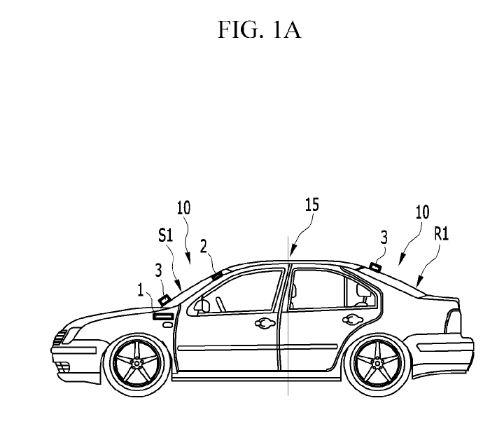

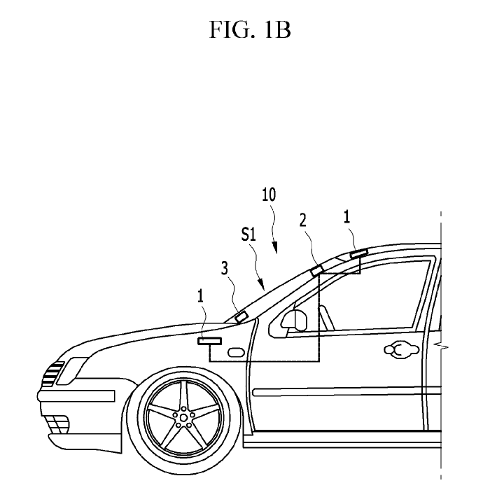

FIG. 1A is a schematic side view of a vehicle with a wiper system according to an embodiment of the disclosure.

FIG. 1A illustrates a vehicle 15, in particular, a passenger vehicle, with a wiper system 10 at a windshield S1 and a rear window R1. The wiper system 10 includes a first micromechanical device 1 and a second micromechanical device 2. The first micromechanical device 1 is configured to detect a first ambient condition, and the second micromechanical device 2 is configured to detect a second ambient condition, where the first ambient condition is different of the second ambient condition.

The wiper system 10 of FIG. 1A further includes wipers 3 at the windshield S1 and the rear window R1. The first micromechanical device 1 and the second micromechanical device 2 are configured to operate at least one wiper 3 such that the first ambient condition and the second ambient condition are fulfilled. In case that the conditions are fulfilled, the wipers 3 at the windshield S1 and the rear window R1 are configured to remove moisture C1 of the windows W1.

FIG. 1B is a further schematic side view of the vehicle with the wiper system according to FIG. 1A.

FIG. 1B illustrates a magnified view of a front section of the vehicle 15 of FIG. 1A. FIG. 1B is based on FIG 1A and illustrates a connection between the first micromechanical device 1 and the second micromechanical devices 2. The first micromechanical device 1 can be preferably arranged on the windshield W1, and the second micromechanical device 2 can be arranged in a side region or top region of the vehicle.

The first micromechanical device 1 is configured to communicate with the second micromechanical device 2, where the first micromechanical device 1 and the second micromechanical device 2 are configured to operate the wipers 3 such that the first ambient condition and the second ambient condition are fulfilled, and the wipers 3 are configured to remove the moisture C1 of the windshield S1 and the rear window R1.

The first micromechanical device 1 is a temperature sensor, and the first ambient condition is fulfilled when an outside or ambient temperature is between 0° C. and 5° C., preferably between 0° C. and 3° C., and more preferably between 0° C. and 2° C.

The second micromechanical device 2 can be a rain sensor, and the second ambient condition can be fulfilled when the moisture C1 is detected on the windshield S1 and/or the rear window R1.

The second micromechanical device 2 can be an air humidity sensor, and the second ambient condition can be fulfilled when the moisture C1 is detected on the windshield S1 and/or the rear window R1 due to an ambient or outside humidity above 95%.

The second micromechanical device 2 can be a humidity sensor, and the second ambient condition can be fulfilled when the moisture C1 is detected on the windshield S1 and/or the rear window R1 due to a dew point higher than an outside temperature.

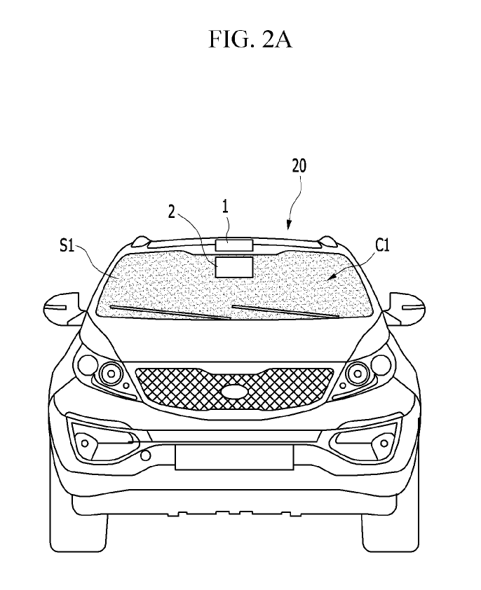

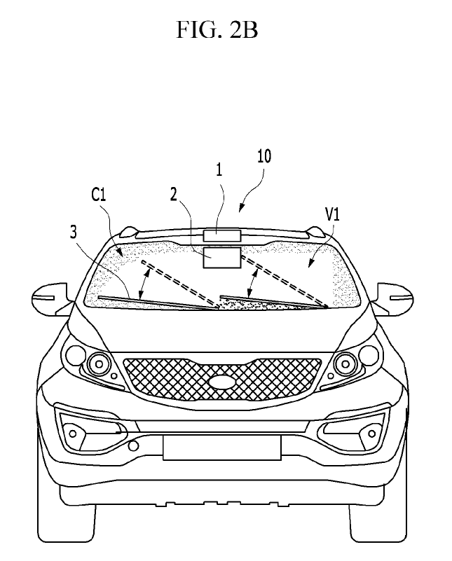

FIGS. 2A and 2B are schematic front views of a vehicle with a wiper system according to a further embodiment of the disclosure.

FIG. 2A illustrates an initial state of the windshield S1 covered with moisture C1 before detecting the first ambient condition.

When the first ambient condition is fulfilled and the second ambient condition is fulfilled the wiper system 10 is activated or initiated and the wipers 3 of the wiper system 10 removes the moisture C1 of the windshield S1.

As a result, as shown in FIG. 2B, a field of view V1 of the windshield S1 is free of the moisture C1. Thus, the field of view V1 cannot be frozen at a temperature below 0° C.

It is clear from the context of this disclosure that the wiper system 10 can also be applied for the rear window R1.

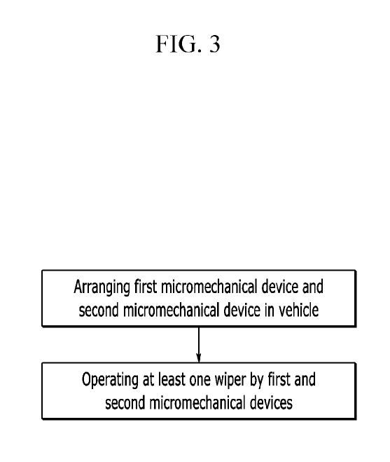

FIG. 3 is a flow chart to illustrate a method for operating the wiper system according to an embodiment of the disclosure.

The method for operating a wiper system 10 for windows W1, in particular, a windshield S1 or rear window R1, includes a step A of arranging a first micromechanical device 1 configured to detect a first ambient condition and a second micromechanical device 2 configured to detect a second ambient condition in a vehicle 15 such that the first micromechanical device 1 communicates with the second micromechanical device 2. The first ambient condition is in particular different from the second ambient condition. The method includes in a further step B of operating at least one wiper 3 by the first micromechanical device 1 and the second micromechanical device 2 such that the first ambient condition and the second ambient condition are fulfilled and removing moisture C1 of the windows W1 via the at least one wiper 3.

The aforementioned wiper system has been described in connection to vehicles or automobiles, accordingly. For a person skilled in the art it is clearly and unambiguously understood that the wiper system can be applied to various object (e.g. airplane) which comprises a wiper system, accordingly.

Although specific embodiments have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

What is claimed is:

1. A wiper system for a vehicle, comprising:
a first micromechanical device configured to detect a first ambient condition; and
a second micromechanical device configured to detect a second ambient condition;
wherein the first micromechanical device is configured to communicate with the second micromechanical device, and the first ambient condition is different from the second ambient condition;
wherein the first micromechanical device and the second micromechanical device are configured to operate at least one wiper such that the first ambient condition and the second ambient condition are fulfilled and the at least one wiper is configured to remove moisture from at least one window of the vehicle.

2. The wiper system according to claim 1, wherein the moisture comprises condensed water and/or rain.

3. The wiper system according to claim 1, wherein the first micromechanical device is a temperature sensor, and the first ambient condition is fulfilled when an outside temperature is between 0° C. and 5° C.

4. The wiper system according to claim 1, wherein the second micromechanical device is a rain sensor, and the second ambient condition is fulfilled when the moisture is detected on the at least one window.

5. The wiper system according to claim 1, wherein the second micromechanical device is an air humidity sensor, and the second ambient condition is fulfilled when the moisture is detected on the at least one window due to an ambient humidity above 95%.

6. The wiper system according to claim 1, wherein the second micromechanical device is a humidity sensor, and the second ambient condition is fulfilled when the moisture is detected on the at least one window due to a dew point higher than an outside temperature.

7. The wiper system according to claim 1, wherein the at least one wiper is configured to remove the moisture of a field of view of a windshield or a rear window.

8. The wiper system according to claim 1, wherein the at least one wiper is configured to operate under reduced wiper speed when the first ambient condition and the second ambient condition are fulfilled.

9. A method for operating a wiper system, comprising the steps of:
arranging a first micromechanical device configured to detect a first ambient condition and a second micromechanical device configured to detect a second ambient condition in a vehicle such that the first micromechanical device communicates with the second micromechanical device; and
operating at least one wiper by the first micromechanical device and the second micromechanical device such that the first ambient condition and the second ambient condition are fulfilled and removing moisture of at least one window via the at least one wiper.
